(19) United States
(12) Patent Application Publication
(10) Pub. No.: US 2026/0119104 A1
(43) Pub. Date: Apr. 30, 2026

(54) INFORMATION PROCESSING APPARATUS, AGENT SYSTEM, METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Naoki UENOYAMA, Kasugai-shi (JP); Yuya KANEHANA, Nagakute-shi (JP)

(73) Assignee: TOYOTA JIDOSHA KABUSHIKI KAISHA, Toyota-shi (JP)

(21) Appl. No.: 19/367,963

(22) Filed: Oct. 24, 2025

(30) Foreign Application Priority Data
Oct. 31, 2024 (JP) 2024-192487

(51) Int. Cl. G06F 3/14; G07C 5/02

(52) U.S. Cl. CPC G06F 3/14; G07C 5/02

(57) ABSTRACT

An information processing apparatus includes a controller configured to control simultaneous display of multiple types of content to a user who is an occupant of a vehicle. The controller acquires content data indicating content scores set for respective types of content and user data indicating histories of operations performed by the user in the past on the respective types of content, calculates, for each type of content, a priority score indicating priority of display, based on a content score indicated by the content data and an operation history indicated by the user data, and arranges and displays the multiple types of content in descending order of the priority scores calculated.

### CROSS-REFERENCE TO RELATED APPLICATION

This application claims priority to Japanese Patent Application No. 2024-192487 filed on Oct. 31, 2024, the entire contents of which are incorporated herein by reference.

### TECHNICAL FIELD

The present disclosure relates to an information processing apparatus, an agent system, a method, and a program.

### BACKGROUND

Patent Literature (PTL) 1 discloses technology for preferentially reproducing and outputting a certain type of content according to priority of each type of content when the timings of reproducing and outputting multiple types of content overlap.

### CITATION LIST

### Patent Literature

PTL 1: JP 2023-103122 A

### SUMMARY

When multiple types of content are displayed simultaneously, content displayed at lower portions of screens may be overlooked by users. For example, overlooking content that affects the safety or the like of vehicles may lead to risks such as accidents. Overlooking content related to information of high user interest causes inconvenience to the users.

It would be helpful to make specific content less likely to be overlooked even when multiple types of content are displayed simultaneously.

An information processing apparatus according to an embodiment of the present disclosure includes a controller configured to control simultaneous display of multiple types of content to a user who is an occupant of a vehicle, wherein the controller is configured to:

acquire content data indicating content scores set for respective types of content and user data indicating histories of operations performed by the user in the past on the respective types of content, and calculate, for each type of content, a priority score indicating priority of display, based on a content score indicated by the content data and an operation history indicated by the user data; and

arrange and display the multiple types of content in descending order of the priority scores calculated.

According to the present disclosure, it is possible to make specific content less likely to be overlooked even when multiple types of content are displayed simultaneously.

### BRIEF DESCRIPTION OF THE DRAWINGS

In the accompanying drawings:

FIG. 1 is a block diagram illustrating a configuration of a system according to an embodiment of the present disclosure;

FIG. 2 is a diagram for explaining a content display screen according to the embodiment of the present disclosure;

FIG. 3 is a block diagram illustrating a configuration of an information processing apparatus according to the embodiment of the present disclosure;

FIG. 4 is a flowchart illustrating operations of the information processing apparatus according to the embodiment of the present disclosure;

FIG. 5 is a diagram for explaining content scores according to the embodiment of the present disclosure;

FIG. 6 is a diagram for explaining user scores according to the embodiment of the present disclosure;

FIG. 7 is a diagram for explaining priority scores according to the embodiment of the present disclosure;

FIG. 8 is a diagram illustrating a specific example of the content display screen according to the embodiment of the present disclosure;

FIG. 9 is a diagram illustrating categories into which respective types of content according to the embodiment of the present disclosure are classified; and

FIG. 10 is a diagram illustrating another specific example of the content display screen according to the embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified as appropriate.

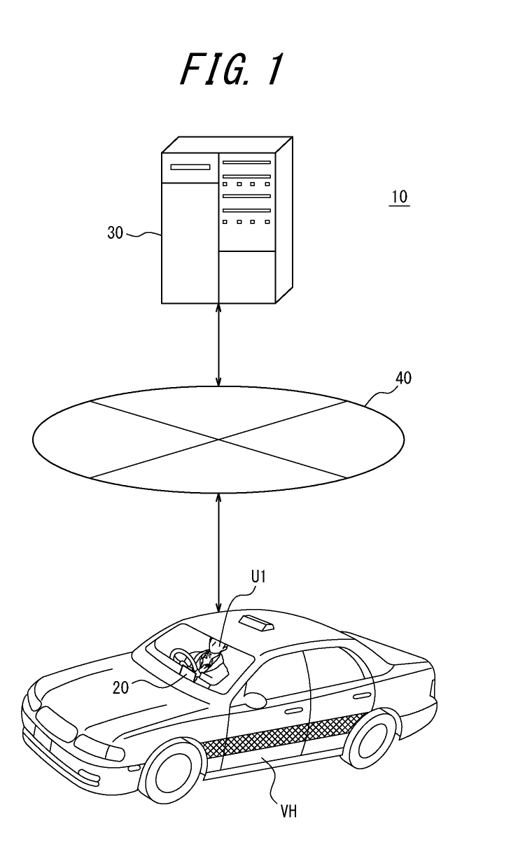

A configuration of an agent system 10 according to the present embodiment will be described with reference to FIG. 1.

The agent system 10 includes at least one information processing apparatus 20 and at least one server apparatus 30. The information processing apparatus 20 is installed in a vehicle VH.

The information processing apparatus 20 can communicate with the server apparatus 30 via a network 40.

The information processing apparatus 20 is a terminal device installed in the vehicle VH. The information processing apparatus 20 may be, for example, a car navigation device, a mobile phone, a smartphone, a tablet, or a PC. The term "PC" is an abbreviation of personal computer.

The vehicle VH is an EV in the present embodiment, but may be any type of automobile such as a gasoline vehicle, a diesel vehicle, an HV, a PHV, or an FCV. The term "EV" is an abbreviation of electric vehicle. The term "HV" is an abbreviation of hybrid vehicle. The term "PHV" is an abbreviation of plug-in hybrid vehicle. The term "FCV" is an abbreviation of fuel cell vehicle. The vehicle VH is driven by a user U1 in the present embodiment, but the driving may be automated at any level. The automation level is, for example, any one of Level 1 to Level 5 according to the level classification defined by SAE. The name "SAE" is an abbreviation of Society of Automotive Engineers. The vehicle VH may be a MaaS-dedicated vehicle. The term "MaaS" is an abbreviation of Mobility as a Service.

The server apparatus 30 is a computer that belongs to a cloud computing system or other computing system installed in a facility such as a data center. The server apparatus 30 may be an agent apparatus equipped with a software agent that automatically performs specific tasks.

The network 40 includes the Internet, at least one WAN, at least one MAN, or any combination thereof. The term "WAN" is an abbreviation of wide area network. The term "MAN" is an abbreviation of metropolitan area network.

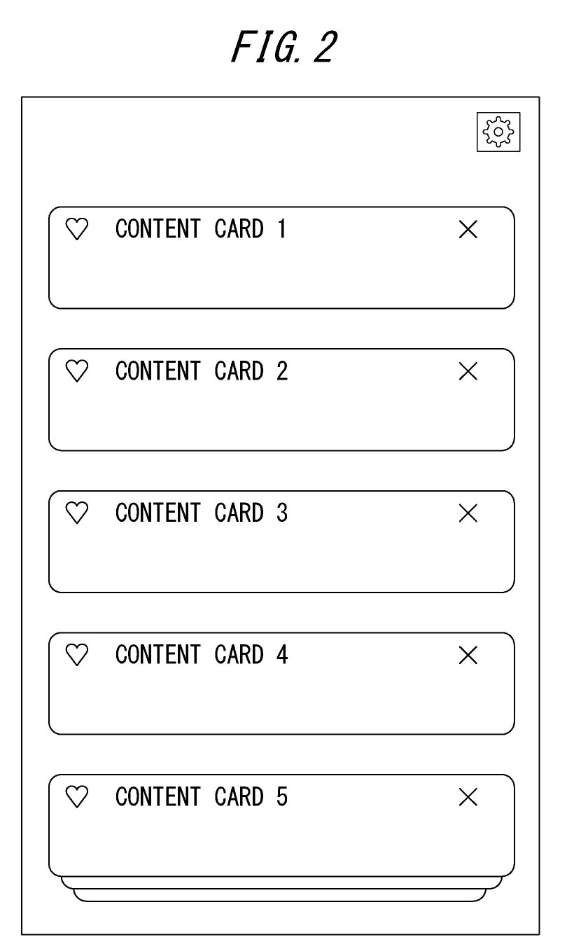

An outline of the present embodiment will be described with reference to FIGS. 1 and 2.

To improve driving experience, agent systems that provide various information, i.e., content to occupants including drivers of vehicles are known. Examples of such agent systems include systems that monitor data over networks and notify when anomalies have occurred, systems that search for and provide information based on user instructions, and the like. The content that the occupants of the vehicles can obtain is expected to be a wide variety of types. By displaying such content as images on a single in-vehicle display, multiple types of content can be provided simultaneously. Examples of the in-vehicle display include, for example, a center display for a car navigation device, a head-up display that projects information onto a windshield, and the like. A content display screen that displays multiple types of content may be displayed at any timing, for example, by a manual operation for screen startup by the user U1. The content display screen may be automatically displayed when the user U1 has gotten into the vehicle VH, or when the traveling vehicle VH has been parked.

In the present embodiment, such multiple types of content are provided from the server apparatus 30. The server apparatus 30 has a suggestion function to suggest content. The suggestion of the content by the server apparatus 30 is made based on data for determining the presence or absence of suggestion. The content may be provided after being selected by an agent function installed in the server apparatus 30, depending on the time and situation. The selection of the content by the server apparatus 30 may be performed by any procedure, but is carried out, for example, by the following procedure. The server apparatus 30 acquires, as the data for determining the presence or absence of suggestion, vehicle information indicating the travel state of the vehicle VH, from a sensor that detects the vehicle information. The server apparatus 30 determines the state of the vehicle VH based on the acquired vehicle information. For example, the server apparatus 30 determines whether the vehicle VH is in motion or stopped. Based on the result of determining the state of the vehicle VH, the server apparatus 30 selects a set of multiple types of content to be displayed by the information processing apparatus 20. The server apparatus 30 provides the selected set to the information processing apparatus 20. The server apparatus 30 transmits, to the information processing apparatus 20, the content to be provided to the user U1.

The information processing apparatus 20 controls simultaneous display of the multiple types of content to the user U1 who is an occupant of the vehicle VH. As illustrated in FIG. 2, in the present embodiment, the multiple types of content are displayed in the form of content cards. The content display screen illustrated in FIG. 2 displays five content cards, i.e., "Content Card 1" to "Content Card 5" as the multiple types of content, but the number of content cards is not limited to five. For example, the user U1 may scroll the content display screen upward to sequentially display content from "Content Card 5" onward. The user U1 can touch a "heart" mark located at the top left of each content card to register desired content as a favorite. The user U1 can touch an "x" mark located at the top right of each content card to close the content card. Each content card may have a sub-display, such as "View Details," according to the details of content, and the user U1 may touch the sub-display to view the details of desired content. In other words, when the user U1 performs an operation of touching the sub-display, the details of the content are displayed. Alternatively, the user U1 may perform a long pressing operation on a desired content card to view the details of the content. The "long pressing operation" refers to an operation by which a screen, such as a touch screen, is touched and kept pressed for a certain period of time or longer. The user U1 may move while keeping touching any content card to change the arrangement order of the content card.

When the multiple types of content are displayed simultaneously, the user U1 has to explicitly rearrange the priority of the content through operations, which is cumbersome. Additionally, the priority of content has to be revised each time the number of the types of content increases, which makes it difficult to display the content at an intended priority when the number of the types of content increases or decreases.

Therefore, the information processing apparatus 20 according to the present embodiment acquires content data D1 indicating content scores set for respective types of content, and user data D2 indicating histories of operations performed by the user U1 in the past on the respective types of content. The operations performed by the user U1 in the past include, for example, operations to close content cards, operations to view the details of content, and the like. The operations performed by the user U1 in the past may also include operations to change the order of content cards, and operations to register content as favorites. These operations are accumulated as the user data D2.

The information processing apparatus 20 calculates, for each type of content, a priority score indicating priority of display, based on a content score indicated by the content data D1 and an operation history indicated by the user data D2. The information processing apparatus 20 arranges and displays multiple types of content in descending order of the priority scores calculated.

According to the present embodiment, the multiple types of content are displayed simultaneously. Therefore, compared to a case in which only one type of content is presented at a time, such as when content is provided via audio, the amount of information presented to the user U1 can be increased. The information processing apparatus 20 calculates the priority for each type of content, and arranges and displays the content in descending order of the priority. Therefore, it is possible to optimize the display order of the information to be presented. As a result, it is possible to make specific content, such as important content, less likely to be overlooked. Therefore, technology for presenting information such as content is improved.

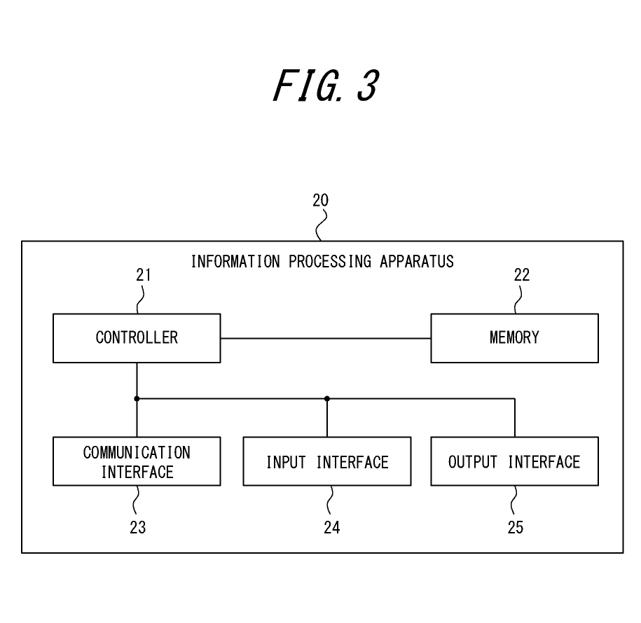

A configuration of the information processing apparatus 20 according to the present embodiment will be described with reference to FIG. 3.

The information processing apparatus 20 includes a controller 21, a memory 22, a communication interface 23, an input interface 24, and an output interface 25.

The controller 21 includes at least one processor, at least one programmable circuit, at least one dedicated circuit, or a combination thereof. The processor is a general purpose processor such as a CPU or a GPU, or a dedicated processor that is dedicated to specific processing. The term "CPU" is an abbreviation of central processing unit. The term "GPU" is an abbreviation of graphics processing unit. The programmable circuit is, for example, an FPGA. The term "FPGA" is an abbreviation of field-programmable gate array. The dedicated circuit is, for example, an ASIC. The term "ASIC" is an abbreviation of application specific integrated circuit. The controller 21 executes processes related to operations of the information processing apparatus 20 while controlling components of the information processing apparatus 20.

The memory 22 includes at least one semiconductor memory, at least one magnetic memory, at least one optical memory, or a combination of at least two of these. The semiconductor memories are, for example, RAM or ROM. The term "RAM" is an abbreviation of random-access memory. The term "ROM" is an abbreviation of read only memory. The RAM is, for example, SRAM or DRAM. The term "SRAM" is an abbreviation of static random-access memory. The term "DRAM" is an abbreviation of dynamic random-access memory. The ROM is, for example, EEPROM. The term "EEPROM" is an abbreviation of electrically erasable programmable read only memory. The memory 22 functions as, for example, a main memory, an auxiliary memory, or a cache memory. The memory 22 stores data to be used for operations of the information processing apparatus 20 and data obtained by operations of the information processing apparatus 20. Furthermore, in the present embodiment, the memory 22 stores content transmitted from the server apparatus 30, and content data D1 indicating content scores set for respective types of content. The content data D1 will be described later. In the present embodiment, the content scores are set in advance for the respective types of content, and the content data D1 is information indicating the content scores. The memory 22 may store user data D2. The user data D2 is information indicating histories of operations performed by the user U1 in the past for the respective types of content. The histories of operations include the types of operations performed by the user U1.

The communication interface 23 includes at least one interface for communication. The communication interface 23 receives data to be used for operations of the information processing apparatus 20, and transmits data obtained by operations of the information processing apparatus 20. In the present embodiment, the communication interface 23 communicates with the server apparatus 30.

The input interface 24 includes at least one interface for input. The interface for input is, for example, a physical key, a capacitive key, a pointing device, a touch screen integrally provided with a display, a voice sensor, or the like. The input interface 24 accepts an operation for inputting data to be used for operations of the information processing apparatus 20. The input interface 24, instead of being included in the information processing apparatus 20, may be connected to the information processing apparatus 20 as an external input device. As the connection method, any method such as USB, HDMI^{®} (HDMI is a registered trademark in Japan, other countries, or both), or Bluetooth^{®} (Bluetooth is a registered trademark in Japan, other countries, or both) can be used. The term "USB" is an abbreviation of Universal Serial Bus. The term "HDMI^{®}" is an abbreviation of High-Definition Multimedia Interface. In the present embodiment, the input interface 24 is a touch screen.

The output interface 25 includes at least one interface for output. The interface for output is, for example, a display or a speaker. The display is, for example, an LCD or an organic EL display. The term "LCD" is an abbreviation of liquid crystal display. The term "EL" is an abbreviation of electro luminescence. The output interface 25 outputs data obtained by operations of the information processing apparatus 20. The output interface 25 may output data transmitted from the server apparatus 30 to the information processing apparatus 20. The output interface 25, instead of being included in the information processing apparatus 20, may be connected to the information processing apparatus 20 as an external output device. As the connection method, any method such as USB, HDMI^{®}, or Bluetooth^{®} can be used. In the present embodiment, the output interface 25 is a display.

The functions of the information processing apparatus 20 are realized by execution of a program according to the present embodiment by a processor serving as the controller 21. That is, the functions of the information processing apparatus 20 are realized by software. The program causes a computer to execute operations of the information processing apparatus 20, thereby causing the computer to function as the information processing apparatus 20. That is, the computer executes the operations of the information processing apparatus 20 in accordance with the program to thereby function as the information processing apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term "SD" is an abbreviation of Secure Digital. The term "DVD" is an abbreviation of digital versatile disc. The term "CD-ROM" is an abbreviation of compact disc read only memory. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using the processor, and executes processes in accordance with the read program using the processor. The computer may read the program directly from the portable medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term "ASP" is an abbreviation of application service provider. The program encompasses information that is to be used for processing by an electronic computer and is thus equivalent to a program. For example, data that is not a direct command to a computer but has a property that regulates processing of the computer is "equivalent to a program" in this context.

Some or all of the functions of the information processing apparatus 20 may be realized by a programmable circuit or a dedicated circuit serving as the controller 21. That is, some or all of the functions of the information processing apparatus 20 may be realized by hardware.

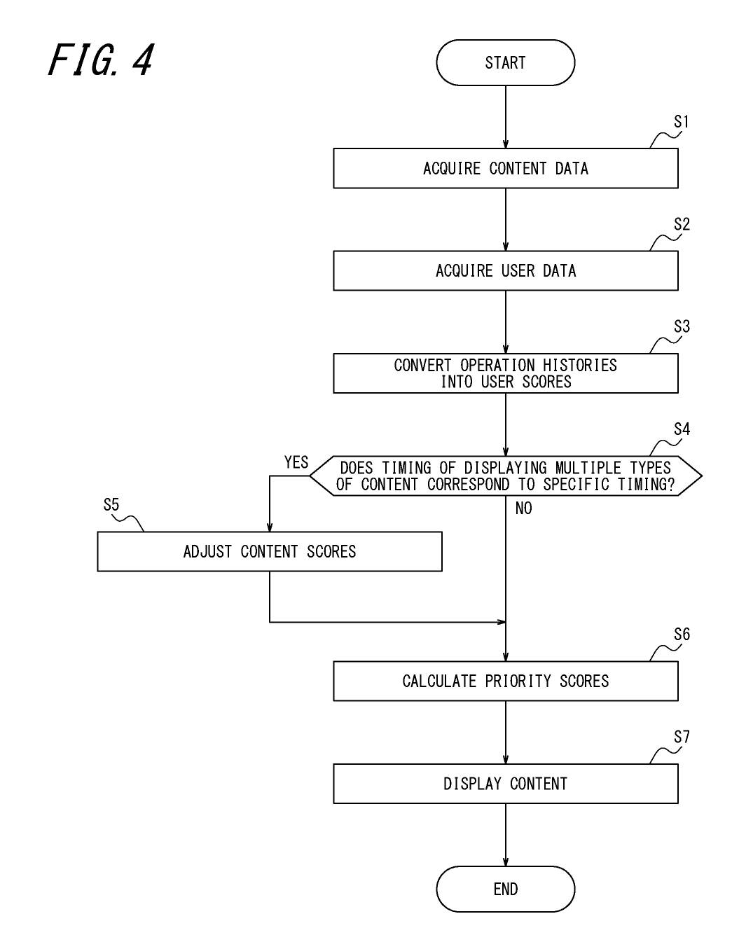

Operations of the agent system 10 according to the present embodiment will be described with reference to FIGS. 4-10. These operations correspond to a method according to the present embodiment. In other words, the method according to the present embodiment includes steps S1 to S7 illustrated in FIG. 4. Hereinafter, each step of the flowchart will be identified by S and a number.

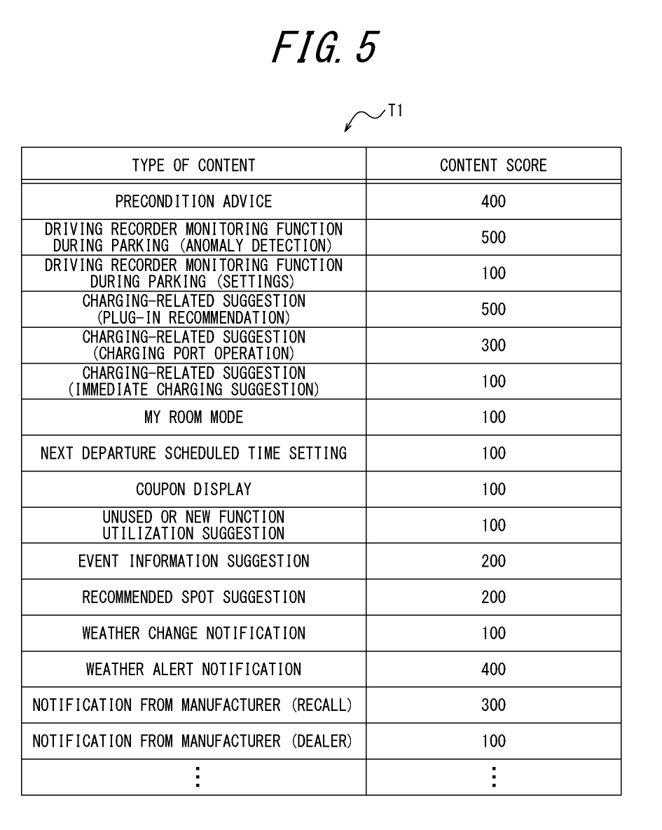

In S1 of FIG. 4, the controller 21 of the information processing apparatus 20 acquires content data D1. The content data D1 is information indicating content scores set for respective types of content. The content data D1 may be acquired by any procedure, such as by the following means. In the present embodiment, multiple types of content have content scores set in advance for the respective types of content. The content data D1 indicating the content scores set for the respective types of content is stored in the memory 22, for example, in the form of Table T1 illustrated in FIG. 5. The controller 21 acquires the content data D1 by reading the content data D1 from the memory 22. Alternatively, the content data D1 may be stored in a cloud, and the controller 21 may acquire the content data D1 from the cloud.

With reference to FIG. 5, the content scores set for the respective type of content will be described. As illustrated in Table T1 of FIG. 5, the content score for a type of content "Precondition Advice" is set to "400." Similarly, the content score for a type of content "Driving Recorder Monitoring Function During Parking (Anomaly Detection)" is set to "500," for "Driving Recorder Monitoring Function During Parking (Settings)" is set to "100," for "Charging-Related Suggestion (Plug-in Recommendation)" is set to "500," for "Charging-Related Suggestion (Charging Port Operation)" is set to "300," for "Charging-Related Suggestion (Immediate Charging Suggestion)" is set to "100," for "My Room Mode" is set to "100," for "Next Departure Scheduled Time Setting" is set to "100," for "Coupon Display" is set to "100," for "Unused or New Function Utilization Suggestion" is set to "100," for "Event Information Suggestion" is set to "200," for "Recommended Spot Suggestion" is set to "200," for "Weather Change Notification" is set to "100," for "Weather Alert Notification" is set to "400," for "Notification From Manufacturer (Recall)" is set to "300," and for "Notification From Manufacturer (Dealer)" is set to "100." These content scores are stored in Table T1. The types of content and the content scores are illustrative, and can be freely determined by an administrator of the agent system 10.

The types of content illustrated in Table T1 of FIG. 5 will be described. "Precondition Advice" is a type of content that suggests the user U1 change the timer settings when the user U1 did not board the vehicle VH during timer-controlled air conditioning. "Driving Recorder Monitoring Function During Parking (Anomaly Detection)" is a type of content for notifying the user U1 of anomalies detected by a driving recorder monitoring function while the vehicle is parked. "Driving Recorder Monitoring Function During Parking (Settings)" is a type of content that enables the user U1, while not on board the vehicle VH, to turn ON or OFF the parking monitoring function of a driving recorder installed in the vehicle VH. "Charging-Related Suggestion (Plug-in Recommendation)" is a type of content that recommends the user U1 to charge the vehicle VH when the battery level is low and/or the ambient temperature is low. "Charging-Related Suggestion (Charging Port Operation)" is a type of contents that enables the user U1 to open and close the electric charging lid of the vehicle VH. "Charging-Related Suggestion (Immediate Charging Suggestion)" is a type of content that recommends the user U1 temporarily cancel the timer-controlled charging instruction and start charging the vehicle VH when the vehicle VH is plugged in and a timer-controlled charging instruction is active. The "timer-controlled charging instruction" is a function that enables charging of the vehicle VH to begin and end at a time previously set by the user U1. "My Room Mode" is a type of content that suggests a mode for keeping systems like air conditioning active when the vehicle's door is opened. "Next Departure Scheduled Time Setting" is a type of content that displays the ON/OFF states of air conditioning and battery preconditioning for the next departure time. "Coupon Display" is a type of content that displays information on coupons available at facilities near the location where the vehicle VH has arrived. "Unused or New Function Utilization Suggestion" is a type of content that recommends the user U1 make use of unused functions and/or newly added functions. "Event Information Suggestion" is a type of content that introduces events taking place around the current location and/or a destination of the vehicle VH. "Recommended Spot Suggestion" is a type of content that introduces popular spots such as tourist attractions near the current location and/or the destination of the vehicle VH. "Weather Change Notification" is a type of content that notifies the user U1 of expected weather changes over the next few hours. "Weather Alert Notification" is a type of content that notifies the user U1 of weather alerts that have been issued. "Notice From Manufacturer (Recall)" is a type of content that notifies the user U1 of products subject to recall. "Notice From Manufacturer (Dealer)" is a type of content that notifies the user U1 of service information from a dealer. The types of content are not limited to these and may include any type of content.

In S2 of FIG. 4, the controller 21 of the information processing apparatus 20 acquires user data D2. The user data D2 is information indicating histories of operations performed by the user U1 in the past on the respective types of content. The user data D2 may be acquired by any procedure, such as by the following means. In the present embodiment, a recording apparatus or the like installed in the vehicle VH records, for the respective types of content, operations performed by the user U1 on content, such as operations of closing content cards and operations of viewing the details of content. The controller 21 acquires data recorded by the recording apparatus via the communication interface 23. The controller 21 calculates priority scores, by adjusting the content scores indicated by the content data D1, based on the operation histories indicated by the user data D2. Specifically, the processes of S3 and S6 of FIG. 4 are performed.

In S3 of FIG. 4, the controller 21 of the information processing apparatus 20 converts the operation histories indicated by the user data D2 into user scores. In the present embodiment, the user scores are set for respective types of operations performed by the user U1. For example, assuming that a user score "X" is set for a certain operation performed by the user U1 on a certain content card. In this case, the controller 21 detects that operation and converts the operation into the user score "X." As an example, a user score of "-3" is set for one operation of closing a content card, and a user score of "+1" is set for one operation of viewing the details of content. With reference to the operation histories, the controller 21 detects the types of operations performed by the user U1. Specifically, the controller 21 detects, for each type of content, operations of closing content cards and operations of viewing the details of content. The controller 21 converts each operation of closing a content card into a user score of "-3", and converts each operation of viewing the details of content into a user score of "+1." In this example, the default value of the user score is 10, the minimum value is 0, and the maximum value is 100. In the present embodiment, the system is configured to turn off notifications, meaning that the corresponding content card will no longer be displayed when the user score reaches its minimum value. The method of converting the user score is illustrative and can be freely determined by the administrator of the agent system 10. For example, a positive user score may be set for an operation of the user U1 rearranging a certain content card above its current position, and a negative user score may be set for an operation of the user U1 rearranging a content card below. The controller 21 may detect operations of the user U1 rearranging content cards above or below the current positions, and convert the operations into user scores set for those operations. In a case in which the operations of rearranging the content cards are converted into the user scores, when a user score falls to the minimum value or lower as the result of repeated operations of rearranging a certain content card below, the score of that content card may be calculated as "the minimum value + 1." This means that when an operation of closing a certain content card is repeated, the user U1 intends to turn OFF notification for that content card, but when the priority of the content card is lowered by rearranging the content card, the user U1 does not intend to turn OFF the notification for that content card (the user U1 intends to display the content card), so the user score is set not to drop below "the minimum value + 1" to ensure that the content card is notified.

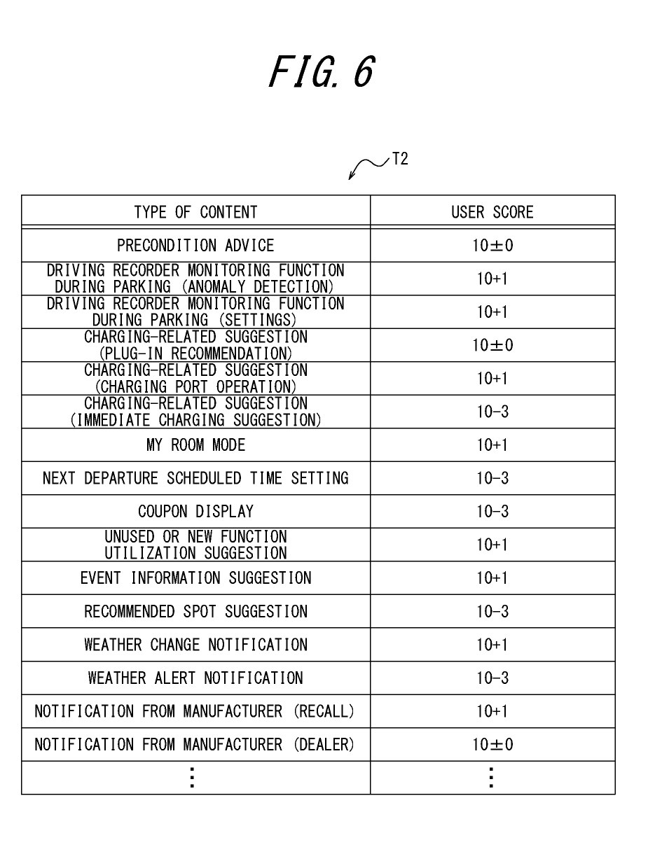

With reference to FIG. 6, the user scores, into which the operations of the user U1 on the respective types of content have been converted, will be described. As illustrated in Table T2 of FIG. 6, the user score for the type of content "Precondition Advice" is "10±0." This means that no operations by the user U1 have been detected for the type of content "Precondition Advice." The same applies to "Charging-Related Suggestion (Plug-in Recommendation)" and "Notification From Manufacturer (Dealer)." The user score for the type of content "Driving Recorder Monitoring Function During Parking (Anomaly Detection)" is "10+1." This means that, as an operation of the user U1 for the type of content "Driving Recorder Monitoring Function During Parking (Anomaly Detection)," one operation of viewing the details of content has been detected. The same applies to "Driving Recorder Monitoring Function During Parking (Settings)," "Charging-Related Suggestion (Charging Port Operation)," "My Room Mode," "Unused or New Function Utilization Suggestion," "Event Information Suggestion," "Weather Change Notification," and "Notification From Manufacturer (Recall)." The user score for the type of content "Charging-Related Suggestion (Immediate Charging Suggestion)" is "10-3." This means that, as an operation of the user U1 for the type of content "Charging-Related Suggestion (Immediate Charging Suggestion)," one operation of closing a content card has been detected. The same applies to "Next Departure Scheduled Time Setting," "Coupon Display," "Recommended Spot Suggestion," and "Weather Alert Notification."

In S6 of FIG. 4, the controller 21 of the information processing apparatus 20 calculates, for each type of content, a priority score by adding a user score to a content score. Specifically, the controller 21 determines a content score for each type of content with reference to the content data D1 acquired in S1, and calculates a priority score for each type of content by adding the user score converted in S3 to the determined content score. For example, when the determined content score for the type of content "Precondition Advice" is "400," and the user score converted from the operation of the user U1 for the type of content "Precondition Advice" in S3 is "10±0," the controller 21 calculates the priority score for the type of content "Precondition Advice" as 400+10=410.

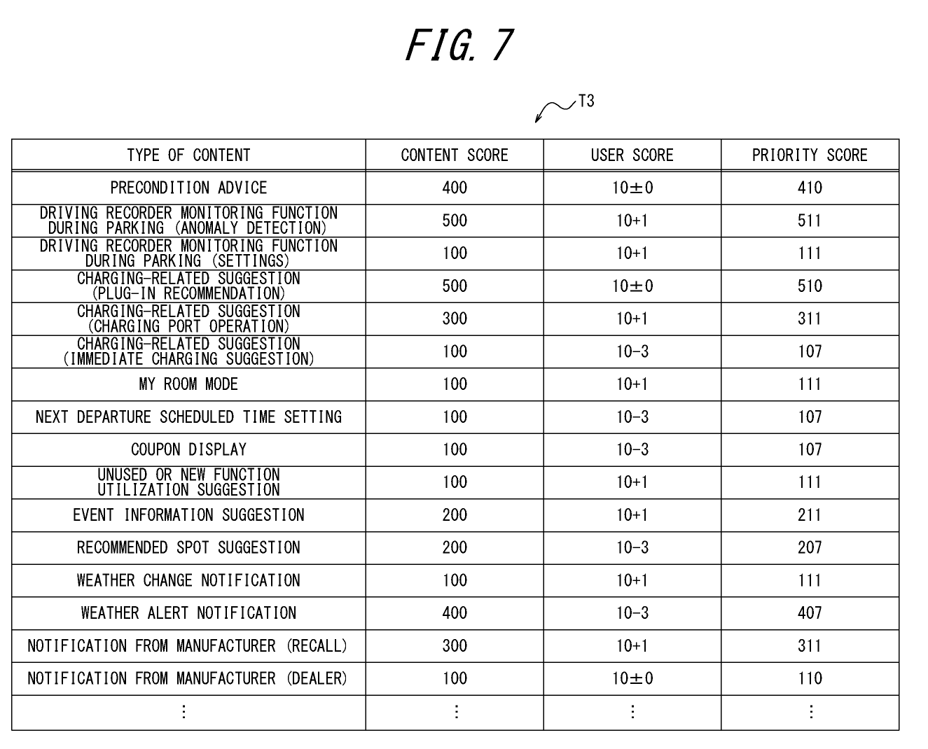

With reference to FIG. 7, the priority score calculated for each type of content will be described. As illustrated in table T3 of FIG. 7, the priority score is calculated for each type of content. As described above, the priority score is the sum of the content score and the user score, and the priority score for "Precondition Advice" is "410." Similarly, the priority score for "Driving Recorder Monitoring Function During Parking (Anomaly Detection)" is "511," the priority score for "Driving Recorder Monitoring Function During Parking (Settings)" is "111," the priority score for "Charging-Related Suggestion (Plug-in Recommendation)" is "510," the priority score for "Charging-Related Suggestion (Charging Port Operation)" is "311," the priority score for "Charging-Related Suggestion (Immediate Charging Suggestion)" is "107," the priority score for "My Room Mode" is "111," the priority score for "Next Departure Scheduled Time Setting" is "107," the priority score for "Coupon Display" is "107," the priority score for "Unused or New Function Utilization Suggestion" is "111," the priority score for "Event Information Suggestion" is "211," the priority score for "Recommended Spot Suggestion" is "207," the priority score for "Weather Change Notification" is "111," the priority score for "Weather Alert Notification" is "407," the priority score for "Notification From Manufacturer (Recall)" is "311," and the priority score for "Notification From Manufacturer (Dealer)" is "110."

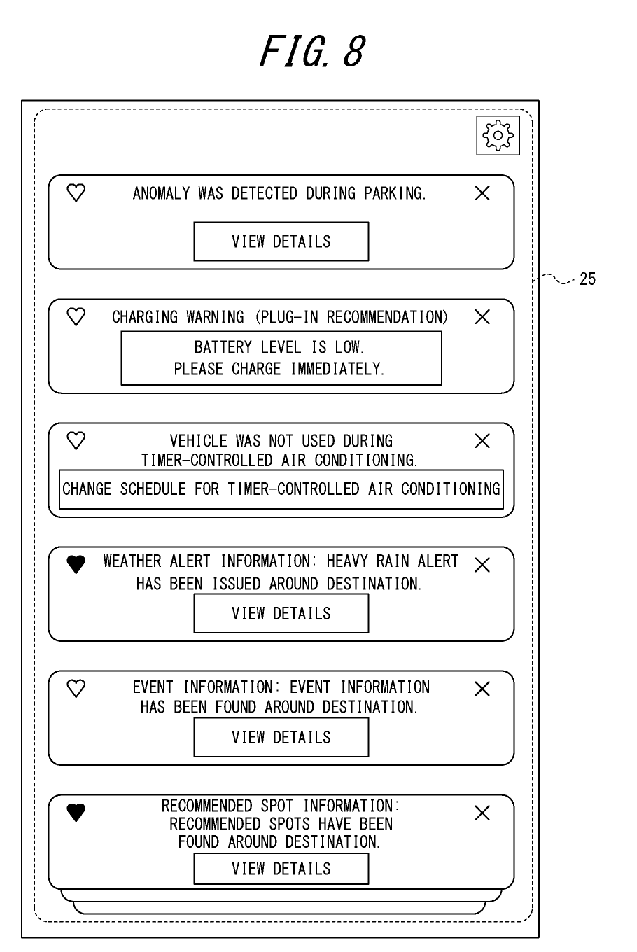

In S7 of FIG. 4, the controller 21 of the information processing apparatus 20 displays multiple types of content in descending order of the priority scores calculated in S6. Specifically, the controller 21 displays, as a content display screen, content cards corresponding to the multiple types of content in descending order of the priority scores, on a display as the output interface 25. As an example, assuming that, as content transmitted from the server apparatus 30 to the information processing apparatus 20, "Driving Recorder Monitoring Function During Parking (Anomaly Detection)," "Charging-Related Suggestion (Plug-in Recommendation)," "Precondition Advice," "Weather Alert Notification," "Event Information Suggestion," and "Recommended Spot Suggestion" are suggested collectively. The priority scores calculated for these types of content are, as illustrated in Table T3 of FIG. 7, "511," "510," "410," "407," "211," and "207." An example of the content display screen displayed in this case is illustrated in FIG. 8. The "example" herein is intended to support the understanding of the present embodiment, rather than to limit the present disclosure. When priority scores are the same, content with a higher user score may have an increased priority.

The content display screen illustrated in FIG. 8 displays, as content cards corresponding to the types of content "Driving Recorder Monitoring Function During Parking (Anomaly Detection)," "Charging-Related Suggestion (Plug-in Recommendation)," "Precondition Advice," "Weather Alert Notification," "Event Information Suggestion," and "Recommended Spot Suggestion," the content cards "Anomaly was detected during parking," "Charging warning (plug-in recommendation)," "Vehicle was not used during timer-controlled air conditioning," "Weather alert information: Heavy rain alert has been issued around destination," "Event information: Event information has been found around destination," and "Recommended spot information: Recommended spots have been found around destination" are arranged and displayed in descending order of the priority scores. Each content card is configured as a touch screen serving as the input interface 24. The content cards corresponding to "Driving Recorder Monitoring Function During Parking (Anomaly Detection)," "Weather Alert Notification," "Event Information Suggestion," and "Recommended Spot Suggestion" are provided with sub-displays of "View Details." The user U1 can view the details of each type of content by touching a sub-display of desired content. The content card corresponding to "Charging-Related Suggestion (Plug-in Recommendation)" has a sub-display stating "Battery level is low. Please charge immediately." When the user U1 touches this sub-display, information such as a map indicating the locations of charging spots may be displayed. The content card corresponding to "Precondition Advice" has a sub-display stating "Change Schedule for Timer-controlled Air Conditioning." When the user U1 touches this sub-display, the screen may transition to a screen for changing a schedule for timer-controlled air conditioning. For the types of content "Event Information Suggestion" and "Recommended Spot Suggestion," the user U1 may have selected in advance which information for "around a destination" or "around the current location" to display. When "around the current location" is selected, content cards stating "Event Information: Event information has been found around current location" and "Recommended Spot Information: Recommended spots have been found around current location" may be displayed. By touching a "heart" mark located at the upper left of each content card, any content can be registered as a favorite. In this example, "Weather Alert Notification" and "Recommended Spot Suggestion" are registered as favorites. The user U1 can close a content card by touching an "x" mark located at the upper right of each content card.

As described above, in the present embodiment, when there are multiple types of content suggested from the server apparatus 30, the controller 21 of the information processing apparatus 20 suggests the multiple types of content collectively after determining priority. The controller 21 acquires content data D1 indicating content scores set for the respective types of content and user data D2 indicating histories of operations performed by the user U1 on the respective types of content, and calculates, for each type of content, a priority score indicating the priority of display, based on a content score indicated by the content data D1 and an operation history indicated by the user data D2. The controller 21 arranges and displays the multiple types of content in descending order of the priority scores calculated.

According to the present embodiment, since multiple types of content can be displayed simultaneously, the amount of information presented can be increased. Since priority can be determined according to the type of content and the multiple types of content can be displayed in descending order of the priority, specific content, such as important information, is less likely to be overlooked. That is, since the priority of content is determined based on operation histories of a user in the past, highly relevant content to the user is more likely to be displayed. This allows the user to quickly access information that is beneficial to the user. Furthermore, by arranging important content in prominent positions, important messages, product information, and the like from a vehicle manufacturer can be more easily delivered to the user. Since the priority is dynamically set based on a content score and a user score, it is possible to display content that corresponds to the behavior of the user in real time. This saves an administrator from having to set the priority manually.

As a variation of the present embodiment, the controller 21 of the information processing apparatus 20 may determine the timing of displaying the multiple types of content, and adjust the content scores based on the determination result. Specifically, the controller 21 may further perform the processes of S4 and S5, after performing the process of S3 before performing the process of S6 in FIG. 4.

In S4 of FIG. 4, the controller 21 of the information processing apparatus 20 determines whether the timing tm of displaying the multiple types of content corresponds to any one of one or more predetermined timings ti. The one or more predetermined timings ti can be determined freely. In this example, the one or more predetermined timings ti include the timing t1 at which the user U1 has performed a manual operation, the timing t2 at which the user U1 has gotten into the vehicle VH, and/or the timing t3 at which the vehicle VH has been parked. Here, the manual operation by the user U1 is an operation in which the user U1 manually starts up the content display screen as illustrated in FIG. 8. When the user U1 performs the manual operation, a suggestion screen display request is transmitted to the information processing apparatus 20, and the content display screen is displayed. Here, the reason for determining the timing tm of displaying the multiple types of content is as follows. That is, the types of content required may change depending on the timing of displaying the multiple types of content. For example, it is preferable to preferentially display content such as "Coupon Display" and "Unused or New Function Utilization Suggestion" at the timing t1 at which the user U1 has performed a manual operation or the timing t2 at which the user U1 has gotten into the vehicle VH. It is preferable to preferentially display content such as "Precondition Advice" and "Driving Recorder Monitoring Function During Parking (Anomaly Detection)" at the timing t2 at which the user U1 has gotten into the vehicle VH. It is preferable to preferentially display content such as "My Room Mode" and "Next Departure Scheduled Time Setting" at the timing t3 at which the vehicle VH has been parked.

These one or more predetermined timings ti can be detected in any procedure. For example, the controller 21 of the information processing apparatus 20 can determine the timing t1 at which the user U1 has performed a manual operation, by detecting a touch operation by the user U1 on a touch screen as the input interface 24 to start up the content display screen, as an operation of the user U1 to manually start up the content display screen. The controller 21 can determine the timing t2 at which the user U1 has gotten into the vehicle VH based on information detected by a pressure sensor installed in a seat of the vehicle VH. The controller 21 may determine the timing t2 based on information from a door sensor that detects the opening and closing of a door of the vehicle VH. The controller 21 may determine a location at which the vehicle VH has been parked, by tracking location information in real-time using a GPS sensor installed in the vehicle VH. Alternatively, the controller 21 may detect the timing t3 at which the vehicle VH has been parked, by detecting that the speed of the vehicle VH has become zero using a speed sensor of the vehicle VH. The controller 21 determines whether the timing tm of displaying the multiple types of content corresponds to a specific timing ti. In this example, the controller 21 determines, as the specific timing ti, whether the timing tm of displaying the multiple types of content corresponds to any one of the timing t1, t2, or t3 described above. When it is determined that the timing tm corresponds to any one of the timing t1, t2, or t3, the process of S5 is performed. When it is determined that the timing tm corresponds to none of the timings t1, t2, and t3, the process of S6 is performed. The process of S6 is as described above.

In S5 of FIG. 4, the controller 21 of the information processing apparatus 20 adjusts the content scores, according to which one of the timing t1, t2, or t3 described above the timing tm of displaying the multiple types of content corresponds to. Specifically, when it is determined that the timing tm corresponds to a certain timing ti, the controller 21 weights the content score of a predetermined type of content associated with that timing ti. In this example, a weighting factor for the content score is specified for each timing ti. As an example, assuming that the content "Coupon Display" and "Unused or New Function Utilization Suggestion" are associated with the timing t1 at which the user U1 has performed a manual operation. When it is determined that the timing tm of displaying the content display screen corresponds to the timing t1, the controller 21 weights the content scores for "Coupon Display" and "Unused or New Function Utilization Suggestion" with a weighting factor specified for the timing t1. Assuming that the content "Precondition Advice" and "Driving Recorder Monitoring Function During Parking (Anomaly Detection)" are associated with the timing t2 at which the user U1 has gotten into the vehicle VH. When it is determined that the timing tm of displaying the content display screen corresponds to the timing t2, the controller 21 weights the content scores for "Precondition Advice" and "Driving Recorder Monitoring Function During Parking (Anomaly Detection)" with a weighting factor specified for the timing t2. Assuming that the content "My Room Mode" and "Next Departure Scheduled Time Setting" are associated with the timing t3 at which the vehicle VH has been parked. When it is determined that the timing tm of displaying the content display screen corresponds to the timing t3, the controller 21 weights the content scores of "My Room Mode" and "Next Departure Scheduled Time Setting" with a weighting factor specified for the timing t3. In this variation, the "weighting factor" indicates the relative importance of each type of content with respect to a certain timing ti as a weight.

In S6 of FIG. 4, the controller 21 of the information processing apparatus 20 calculates the priority score by adding the user score converted in S3 to the content score weighted in S5. The process of S7 is as described above.

According to this variation, the controller 21 of the information processing apparatus 20 determines the timing of displaying the multiple types of content, and adjusts the content scores based on the determination result. The controller 21 determines whether the timing of displaying the multiple types of content corresponds to any one of the one or more predetermined timings ti. Upon determining that the timing of displaying the multiple types of content corresponds to a certain timing, the controller 21 adjusts the content scores by weighting a content score of predetermined content associated with that timing. As a result, the priority score of the content associated with the corresponding timing ti becomes higher than those of content not associated with the timing ti. Therefore, the content associated with the corresponding timing ti is displayed above the content not associated with the timing ti. Thus, content that a user needs at a specific timing is displayed preferentially, which allows the user to quickly access information that the user needs. Moreover, important content is displayed according to a specific timing, which makes it easier to encourage user behavior. Dynamically displaying content according to timing makes it easier to provide highly relevant information in real-time. In other words, this variation can further optimize the order of displaying information to be presented. The one or more predetermined timings ti are not limited to the timings t1, t2, and t3 described above, and can include any timing. Instead of adjusting the content scores according to the corresponding timing, the controller 21 of the information processing apparatus 20 may monitor the travel state of the vehicle VH and adjust the content scores based on whether the vehicle VH is in motion or parked.

As another variation of the present embodiment, the multiple types of content may be classified into multiple categories. The controller 21 of the information processing apparatus 20 may calculate the priority scores for respective types of content classified in the same category, and display, for each category, the multiple types of content in descending order of the priority scores calculated. The multiple categories include a first category C1 including, as first content, content related to vehicle information, a second category C2 including, as second content, content that excludes the content related to the vehicle information and that has been registered in advance by the user U1, and/or a third category C3 including, as third content, content excluding the first content and the second content. In this variation, the content that has been registered in advance by the user U1 is content that the user U1 has registered as a favorite.

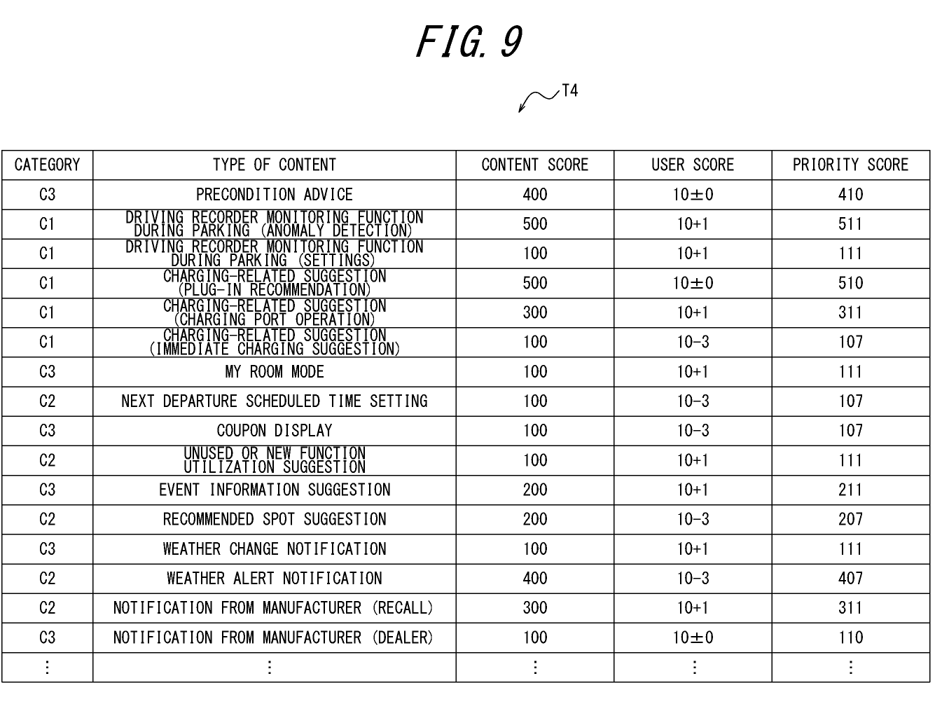

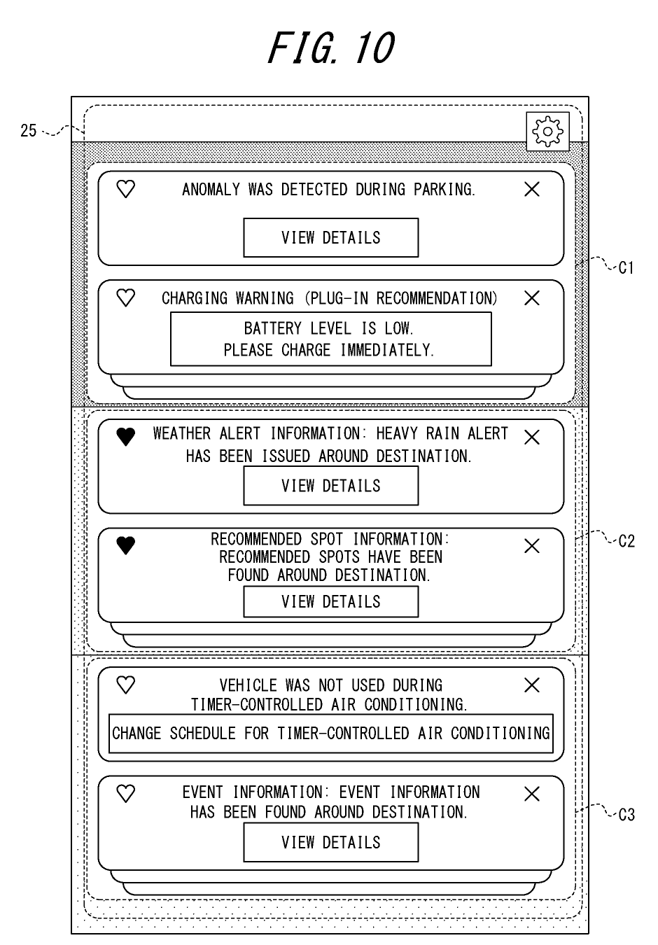

With reference to FIG. 9, a case in which each type of content is classified into any one of the multiple categories will be described. In this variation, as illustrated in Table T4 of FIG. 9, each type of content is classified into any one of the first category C1, the second category C2, or the third category C3. As an example, as content transmitted from the server apparatus 30 to the information processing apparatus 20, "Driving Recorder Monitoring Function During Parking (Anomaly Detection)", "Charging-Related Suggestion (Plug-in Recommendation)", "Precondition Advice", "Weather Alert Notification", "Event Information Suggestion," and "Recommended Spot Suggestion" are collectively suggested, and these types of content are classified as illustrated in Table T4 of FIG. 9. That is, "Driving Recorder Monitoring Function During Parking (Anomaly Detection)" and "Charging-Related Suggestion (Plug-in Recommendation)" are classified into the first category C1, "Weather Alert Notification" and "Recommended Spot Suggestion" are classified into the second category C2, and "Precondition Advice" and "Event Information Suggestion" are classified into the third category C3. An example of the content display screen displayed in this case is illustrated in FIG. 10.

In the content display screen illustrated in FIG. 10, the content cards corresponding to the content classified into the first category C1 are displayed at an upper portion of the screen. The content cards corresponding to the content classified in the second category C2 are displayed in a middle portion of the screen. The content cards corresponding to the content classified in the third category C3 are displayed at a lower portion of the screen. The display area for each category is not limited to this. The order of display for each category can be determined freely, but is preferably determined according to the priority scores. The content display screen illustrated in FIG. 10 is similar to the content display screen illustrated in FIG. 8, except that the content cards are classified into the categories and displayed, for each category, in descending order of the priority scores. In this example, although the priority score of "Precondition Advice," which is "410," is higher than those of "Weather Alert Notification" (priority score "407") and "Recommended Spot Suggestion" (priority score "207"), the content card corresponding to "Precondition Advice" is displayed below the content cards corresponding to "Weather Alert Notification" and "Recommended Spot Suggestion." This is because, in this example, the priority of content is compared for each category, so the content cards corresponding to "Weather Alert Notification" and "Recommended Spot Information," which are registered by the user U1 as favorites and are therefore classified into the second category C2, are displayed above the content card corresponding to "Precondition Advice," which is classified in the third category C3. On the other hand, the priority score "410" of "Precondition Advice" is higher than the priority score "211" of "Event Information Suggestion," which is also classified into the same third category C3. Therefore, in the area in which the third category C3 is displayed at the lower portion of the screen, the content card corresponding to "Precondition Advice" is displayed above the content card corresponding to "Event Information Suggestion."

As described above, according to this variation, the content is classified into categories, and the priority of the content is calculated for each category. Categorizing the content as described above allows a user to search for desired content more easily. Since high-priority content is displayed at the top as a group, the user can quickly access important information and find related other content more easily. Organizing the content by categories allows an administrator to grasp the content more easily and to update or modify the content more easily. In other words, this variation can further optimize the order of displaying information to be presented.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these examples.

[Appendix 1] An information processing apparatus comprising a controller configured to control simultaneous display of multiple types of content to a user who is an occupant of a vehicle, wherein

the controller is configured to acquire content data indicating content scores set for respective types of content and user data indicating histories of operations performed by the user in the past on the respective types of content, and calculate, for each type of content, a priority score indicating priority of display, based on a content score indicated by the content data and an operation history indicated by the user data, and

the controller is configured to arrange and display the multiple types of content in descending order of the priority scores calculated.

[Appendix 2] The information processing apparatus according to appendix 1, wherein the controller is configured to calculate the priority score by adjusting the content score indicated by the content data, based on the operation history indicated by the user data.

[Appendix 3] The information processing apparatus according to appendix 1 or 2, wherein

the operations have user scores set for respective types of operations, and

the controller is configured to detect the type of an operation performed by the user with reference to the operation history, and calculate the priority score by converting the detected type of the operation into a user score and adding the user score to the content score.

[Appendix 4] The information processing apparatus according to any one of appendices 1 to 3, wherein

the multiple types of content are classified into multiple categories,

the controller is configured to calculate priority scores for respective types of content classified into the same category, and

the controller is configured to arrange and display, for each category, the multiple types of content in descending order of the priority scores calculated.

[Appendix 5] The information processing apparatus according to any one of appendices 1 to 4, wherein the multiple categories include a first category including, as first content, content related to vehicle information, a second category including, as second content, content that excludes the content related to the vehicle information and that has been registered in advance by the user, and/or a third category including, as third content, content excluding the first content and the second content.

[Appendix 6] The information processing apparatus according to any one of appendices 1 to 5, wherein the controller is configured to determine the timing of displaying the multiple types of content, and adjust the content scores based on the determination result.

[Appendix 7] The information processing apparatus according to any one of appendices 1 to 6, wherein the controller is configured to determine whether the timing corresponds to any one of one or more predetermined timings, and upon determining that the timing corresponds to a certain timing, adjust the content scores by weighting a content score of predetermined content associated with that timing.

[Appendix 8] The information processing apparatus according to any one of appendices 1 to 7, wherein the timing includes the timing at which the user has performed a manual operation, the timing at which the user has gotten into the vehicle, and/or the timing at which the vehicle has been parked.

[Appendix 9] An agent system comprising:

the information processing apparatus according to any one of appendices 1 to 8; and

a server apparatus configured to:

receive information indicating a travel state of the vehicle, from a sensor that acquires the information;

determine the state of the vehicle based on the information;

select, according to the determination result, a set of multiple types of content to be displayed by the information processing apparatus; and

notify the information processing apparatus of the set of the multiple types of content.

[Appendix 10] A method performed by an information processing apparatus for controlling simultaneous display of multiple types of content to a user who is an occupant of a vehicle, the method comprising:

acquiring, by the information processing apparatus, content data indicating content scores set for respective types of content and user data indicating histories of operations performed by the user in the past on the respective types of content, and calculating, for each type of content, a priority score indicating priority of display, based on a content score indicated by the content data and an operation history indicated by the user data; and

arranging and displaying, by the information processing apparatus, the multiple types of content in descending order of the priority scores calculated.

[Appendix 11] The method according to appendix 10, wherein the calculating of the priority score includes adjusting the content score indicated by the content data, based on the operation history indicated by the user data.

[Appendix 12] The method according to appendix 10 or 11, wherein

the operations have user scores set for respective types of operations, and

the calculating of the priority score includes detecting, by the information processing apparatus, the type of an operation performed by the user with reference to the operation history, and converting the detected type of the operation into a user score and adding the user score to the content score.

[Appendix 13] The method according to any one of appendices 10 to 12, wherein

the multiple types of content are classified into multiple categories,

the calculating of the priority score includes calculating, by the information processing apparatus, priority scores for respective types of content classified into the same category, and

the displaying includes arranging and displaying, by the information processing apparatus for each category, the multiple types of content in descending order of the priority scores calculated.

[Appendix 14] The method according to any one of appendices 10 to 13, wherein the multiple categories include a first category including, as first content, content related to vehicle information, a second category including, as second content, content that excludes the content related to the vehicle information and that has been registered in advance by the user, and/or a third category including, as third content, content excluding the first content and the second content.

[Appendix 15] The method according to any one of appendices 10 to 14, wherein the adjusting of the content score includes determining, by the information processing apparatus, the timing of displaying the multiple types of content, and adjusting the content score based on the determination result.

[Appendix 16] A program configured to cause a computer, as an information processing apparatus for controlling simultaneous display of multiple types of content to a user who is an occupant of a vehicle, to execute operations, the operations comprising:

acquiring content data indicating content scores set for respective types of content and user data indicating histories of operations performed by the user in the past on the respective types of content, and calculating, for each type of content, a priority score indicating priority of display, based on a content score indicated by the content data and an operation history indicated by the user data; and

arranging and displaying the multiple types of content in descending order of the priority scores calculated.

[Appendix 17] The program according to appendix 16, wherein the calculating of the priority score includes adjusting the content score indicated by the content data, based on the operation history indicated by the user data.

[Appendix 18] The program according to appendix 16 or 17, wherein

the operations have user scores set for respective types of operations, and

the calculating of the priority score includes detecting the type of an operation performed by the user with reference to the operation history, and converting the detected type of the operation into a user score and adding the user score to the content score.

[Appendix 19] The program according to any one of appendices 16 to 18, wherein

the multiple types of content are classified into multiple categories,

the calculating of the priority score includes calculating, by the information processing apparatus, priority scores for respective types of content classified into the same category, and

the displaying includes arranging and displaying, by the information processing apparatus for each category, the multiple types of content in descending order of priority scores calculated.

[Appendix 20] The program according to any one of appendices 16 to 19, wherein the adjusting of the content score includes determining the timing of displaying the multiple types of content, and adjusting the content score based on the determination result.

1. An information processing apparatus comprising a controller configured to control simultaneous display of multiple types of content to a user who is an occupant of a vehicle, wherein
the controller is configured to acquire content data indicating content scores set for respective types of content and user data indicating histories of operations performed by the user in past on the respective types of content, and calculate, for each type of content, a priority score indicating priority of display, based on a content score indicated by the content data and an operation history indicated by the user data, and
the controller is configured to arrange and display the multiple types of content in descending order of priority scores calculated.

2. The information processing apparatus according to claim 1, wherein the controller is configured to calculate the priority score by adjusting the content score indicated by the content data, based on the operation history indicated by the user data.

3. The information processing apparatus according to claim 2, wherein
the operations have user scores set for respective types of operations, and
the controller is configured to detect a type of an operation performed by the user with reference to the operation history, and calculate the priority score by converting the detected type of the operation into a user score and adding the user score to the content score.

4. The information processing apparatus according to claim 1, wherein
the multiple types of content are classified into multiple categories,
the controller is configured to calculate priority scores for respective types of content classified into a same category, and
the controller is configured to arrange and display, for each category, the multiple types of content in descending order of the priority scores calculated.

5. The information processing apparatus according to claim 4, wherein the multiple categories include a first category including, as first content, content related to vehicle information, a second category including, as second content, content that excludes the content related to the vehicle information and that has been registered in advance by the user, and/or a third category including, as third content, content excluding the first content and the second content.

6. The information processing apparatus according to claim 1, wherein the controller is configured to determine a timing of displaying the multiple types of content, and adjust the content scores based on a determination result.

7. The information processing apparatus according to claim 6, wherein the controller is configured to determine whether the timing corresponds to any one of one or more predetermined timings, and upon determining that the timing corresponds to a certain timing, adjust the content scores by weighting a content score of predetermined content associated with that timing.

8. The information processing apparatus according to claim 7, wherein the timing includes a timing at which the user has performed a manual operation, a timing at which the user has gotten into the vehicle, and/or a timing at which the vehicle has been parked.

9. An agent system comprising:
the information processing apparatus according to claim 1; and
a server apparatus configured to:
receive vehicle information indicating a travel state of the vehicle, from a sensor that acquires the vehicle information;
determine a state of the vehicle based on the vehicle information;
select, according to a determination result, a set of multiple types of content to be displayed by the information processing apparatus; and
notify the information processing apparatus of the set of the multiple types of content.

10. A method performed by an information processing apparatus for controlling simultaneous display of multiple types of content to a user who is an occupant of a vehicle, the method comprising:
acquiring, by the information processing apparatus, content data indicating content scores set for respective types of content and user data indicating histories of operations performed by the user in past on the respective types of content, and calculating, for each type of content, a priority score indicating priority of display, based on a content score indicated by the content data and an operation history indicated by the user data; and
arranging and displaying, by the information processing apparatus, the multiple types of content in descending order of priority scores calculated.

11. The method according to claim 10, wherein the calculating of the priority score includes adjusting the content score indicated by the content data, based on the operation history indicated by the user data.

12. The method according to claim 11, wherein
the operations have user scores set for respective types of operations, and
the calculating of the priority score includes detecting, by the information processing apparatus, a type of an operation performed by the user with reference to the operation history, and converting the detected type of the operation into a user score and adding the user score to the content score.

13. The method according to claim 10, wherein
the multiple types of content are classified into multiple categories,
the calculating of the priority score includes calculating, by the information processing apparatus, priority scores for respective types of content classified into a same category, and
the displaying includes arranging and displaying, by the information processing apparatus for each category, the multiple types of content in descending order of the priority scores calculated.

14. The method according to claim 13, wherein the multiple categories include a first category including, as first content, content related to vehicle information, a second category including, as second content, content that excludes the content related to the vehicle information and that has been registered in advance by the user, and/or a third category including, as third content, content excluding the first content and the second content.

15. The method according to claim 11, wherein the adjusting of the content score includes determining, by the information processing apparatus, a timing of displaying the multiple types of content, and adjusting the content score based on a determination result.

16. A non-transitory computer readable medium storing a program configured to cause a computer, as an information processing apparatus for controlling simultaneous display of multiple types of content to a user who is an occupant of a vehicle, to execute operations, the operations comprising:
acquiring content data indicating content scores set for respective types of content and user data indicating histories of operations performed by the user in past on the respective types of content, and calculating, for each type of content, a priority score indicating priority of display, based on a content score indicated by the content data and an operation history indicated by the user data; and
arranging and displaying the multiple types of content in descending order of priority scores calculated.

17. The non-transitory computer readable medium according to claim 16, wherein the calculating of the priority score includes adjusting the content score indicated by the content data, based on the operation history indicated by the user data.

18. The non-transitory computer readable medium according to claim 17, wherein
the operations have user scores set for respective types of operations, and
the calculating of the priority score includes detecting a type of an operation performed by the user with reference to the operation history, and converting the detected type of the operation into a user score and adding the user score to the content score.

19. The non-transitory computer readable medium according to claim 16, wherein
the multiple types of content are classified into multiple categories,
the calculating of the priority score includes calculating, by the information processing apparatus, priority scores for respective types of content classified into a same category, and
the displaying includes arranging and displaying, by the information processing apparatus for each category, the multiple types of content in descending order of the priority scores calculated.

20. The non-transitory computer readable medium according to claim 17, wherein the adjusting of the content score includes determining a timing of displaying the multiple types of content, and adjusting the content score based on a determination result.
